(19) United States
(12) Patent Application Publication
(10) Pub. No.: US 2025/0161926 A1
(43) Pub. Date: May 22, 2025

(54) etal catalysts in tandem with carbon-based catalysts for CO2 conversion to carbon-based molecules

(71) Applicant: The Board of Trustees of the Leland Stanford Junior University, Stanford, CA (US)

(72) Inventors: Thomas Francisco Jaramillo, Menlo Park, CA (US); Yi-Rung Lin, Kaohsiung City (TW); David M. Koshy, San Mateo, CA (US); Dong Un Lee, Palo Alto, CA (US); Shunquan Tan, Hamiton (CA); Christopher Hahn, Half Moon Bay, CA (US)

(21) Appl. No.: 18/841,579

(22) PCT Filed: Mar. 15, 2023
(86) PCT No.: PCT/US2023/015255

§ 371 Date: Aug. 26, 2024

Related U.S. Application Data
(60) Provisional application No. 63/320,084, filed on Mar. 15, 2022.

(51) Int. Cl. B01J 31/22; B01J 35/45; C25B 3/01

(52) U.S. Cl. CPC B01J 31/2291; B01J 35/45; C25B 3/01; B01J 2523/17; B01J 2523/847

(57) ABSTRACT

A process for converting carbon dioxide into a carbon-based molecule catalyzes a direct-conversion reaction of a vapor-fed flow of the carbon dioxide to the carbon-based molecule using a tandem electrocatalyst integrated with the gas diffusion electrode. The tandem electrocatalyst is a nanostructure composed of two parts: a copper or a copper-based binary or ternary alloy, and a metal center coordinated to nitrogen-doped carbon (NC) or a NC— containing macrocyclic organic compound. In one specific implementation, the tandem electrocatalyst consists of copper and nickel-coordinated nitrogen-doped carbon (NiNC), and the carbon-based molecule is ethylene. The copper or copper-based binary or ternary alloy may be in the form of nanoparticles, nanocubes, nanotubes, nanoflowers, nanorods, or nanoplates. The metal center coordinated to nitrogen-doped carbon (NC) or to a NC— containing macrocyclic organic compound may be in the form of nanoflowers, nanotubes, nanocages, mesopores, macropores, nanofibers, nanospheres, or other nanostructure.

### FIELD OF THE INVENTION

The present invention relates to techniques for direct conversion of carbon dioxide into carbon-based molecules.

### BACKGROUND OF THE INVENTION

With the concerns of increasing carbon dioxide (CO₂) emission due to intensive human activities that require burning of fossil fuels, balancing the carbon cycle by maximizing the utilization of renewable energy has become an urgent priority. As such, various energy conversion technologies such as water-splitting electrolyzers have been developed to couple with renewable sources of energy like solar, wind, and hydro in order to meet the long-term global sustainability goals. To perform efficient CO₂ utilization, one economically viable way is to couple electrochemical CO₂ electrolyzers for renewable generation of value-added fuels and chemicals while achieving a net-zero carbon cycle.

To date, electrochemical CO₂ reduction (CO₂R) towards single carbon products, in particular CO, has made enormous progress, leading to production levels potentially suited for commercial usages. On the other hand, for multi-carbon (C₂₊) products such as C₂H₄ and C₂H₅OH, which are of particular interest owing to their high market value and flexibility in downstream applications, significant electrocatalyst activity and selectivity advancements are still needed. So far, copper (Cu) has been found to be the only single-metal catalyst known to electrocatalyze the conversion of CO₂ to C₂₊ products and oxygenates at reasonably high rate and selectivity. Among Cu-based catalysts, those with high surface area are reported to be particularly interesting due to improved selectivity towards C₂₊ products at relatively low overpotentials, which could help to lower the energy costs for large-scale industrial applications. However, achieving high selectivity and formation rate towards C₂₊ product formation is difficult due to the complexity of the CO₂R mechanism and diverging reaction pathways on Cu. Thus, a rational design of a catalyst system to enhance product selectivity is necessary to improve the overall catalytic performance and allow for real-world deployment.

Different strategies have been investigated to improve the overall electrocatalytic performance of Cu, such as alloy formation, surface doping, ligand modification, and interface engineering. Recently, the concept of tandem catalysis has attracted much attention due to the capability to sequentially facilitate multiple electrochemical conversions under a single reaction condition, presenting itself as an effective way to generate C₂₊ products. One commonly accepted tandem catalysis reaction pathway is the conversion from CO₂-to-CO followed by CO-to-C₂₊, which are decoupled and facilitated sequentially over two different components in a single catalyst system, resulting in increased conversion to C₂₊ products compared to a single-component catalyst. For instance, bimetallic catalysts, such as Cu—Ag and Cu—Au, have been reported to behave as two phase-separated metals as opposed to a single-phase alloy to facilitate tandem catalysis. Effectively, the generation of CO over Ag or Au is reported to elevate the local CO availability near neighboring Cu, which then promotes CO—CO coupling via the CO spillover phenomenon. However, these bimetallic catalysts face challenges associated with potential in situ alloy formation depending on the dynamics of the metals employed and their miscibility leading to performance degradation.

There have also been investigations of tandem catalysis using a single catalyst, copper oxide-based nanoparticles, by co-feeding varying ratios of CO₂ and CO, showing that the C₂₊ product formation is highly sensitive to the feed composition. Extended investigations of tandem catalysis have been made in which CO₂ reduction is shown by using a mix of two catalysts, one being the CO producer and the other being the CO reducer, loaded on a carbon paper in an H-cell, observing enhancements in the production rate of C₂H₄ at the higher tested overpotential and higher copper oxide content in the electrode. The above two cases show that it is crucial to optimize the CO₂/CO ratios to achieve the highest C₂₊ product formation in CO₂RR. However, when using a single catalyst in CO₂RR, it is particularly challenging to measure and control the local CO₂/CO ratios due to the experimental limitation.

### SUMMARY OF THE INVENTION

Herein is disclosed a process for converting carbon dioxide into a carbon-based molecule. The process includes applying a working voltage to a tandem electrocatalyst integrated with a gas diffusion electrode; providing a vapor-fed flow of the carbon dioxide to the tandem electrocatalyst integrated with the gas diffusion electrode; and catalyzing a direct-conversion reaction of the vapor-fed flow of the carbon dioxide to the carbon-based molecule using the tandem electrocatalyst integrated with the gas diffusion electrode.

The tandem electrocatalyst in one implementation consists of copper and nickel-coordinated nitrogen-doped carbon (NiNC), catalyzing the production of ethylene. The copper may be in the form of nanoparticles, nanocubes, nanotubes, nanoflowers, nanorods, or nanoplates.

More generally, the tandem electrocatalyst may be a nanostructure composed of 1) a copper-based binary or ternary alloy, and 2) a metal center coordinated to a) nitrogen-doped carbon (NC) or b) a NC-containing macrocyclic organic compound.

The copper-based binary or ternary alloy may be in the form Cu—X—Y, where each of X, Y is a transition or post-transition metals. For example, each of X, Y may be Ag, Zn, Al, or Sn. The Cu or copper-based binary or ternary alloy may be in the form of nanoparticles, nanocubes, nanotubes, nanoflowers, nanorods, or nanoplates.

The metal center may be composed of a transition or post-transition metal such as Fe, Co, Ni, Ag, Zn, Al, or Sn. The morphology of metal center coordinated to a NC (X—NC) may be in the form of nanoflowers, nanotubes, nanocages, mesopores, macropores, nanofibers, nanospheres, or other nanostructure

The macrocyclic organic compound may be porphyrins or phthalocyanines with modified ligands.

The carbon-based molecule may be ethylene, ethanol, acetate, or a straight chain hydrocarbon with at least three carbon atoms.

The process may be implemented using a membrane electrode assembly electrolyzer or using a flow electrolyte electrolyzer.

The invention in one aspect provides a sustainable process to convert carbon dioxide into value-added carbon-based molecules. In one example, a tandem electrocatalyst composed of copper nanocubes and nickel-coordinated nitrogen-doped carbon (NiNC), is integrated into gas diffusion electrodes (GDEs) for direct conversion of vapor-fed CO₂ into ethylene.

Ethylene is particularly attractive due to its major importance as a feedstock for various applications including the polymer industry. As such, catalyst and electrolyzer developments are crucial to achieve industrially relevant ethylene production and efficiency levels. Here, we present a tandem electrocatalyst composed of copper nanocubes and nickel-coordinated nitrogen-doped carbon (NiNC), which is integrated into gas diffusion electrodes (GDEs) for direct conversion of vapor-fed CO₂ into ethylene. Evaluation of tandem GDEs in the vapor-fed flow electrolyzer shows significantly increased ethylene selectivity in terms of faradaic efficiency (FE) and C₂H₄/CO ratio compared to a non-tandem copper GDE. The enhancements are attributed to the increased local CO availability near the copper surface via effective CO₂ to CO conversion on neighboring NiNC. The experimental results are validated by 3-dimensional resolved continuum simulations, which shows increased flux of higher-order products with the added CO flux from NiNC. The practical viability of Cu/NiNC catalysts is further evaluated in a membrane electrode assembly electrolyzer, achieving 40% FE towards ethylene at 150 mA cm⁻² and 3.2 V. These findings highlight the high selectivity and formation rate of ethylene achieved by successful device integration of Cu/NiNC catalysts, demonstrating the potential for implementation in large-scale sustainable CO₂ electrolyzers.

Significant advantages are provided. The catalytic performance of these tandem catalyst-based CO₂ electrolyzer shows higher energy conversion efficiencies towards ethylene and lower working voltages than the current ones on market and the literature data. The practical viability of Cu/NiNC catalysts is further evaluated in a membrane electrode assembly electrolyzer, achieving 40% FE towards ethylene at 150 mA cm-2 and 3.2 V. These findings highlight the high selectivity and formation rate of ethylene achieved by successful device integration of Cu/NiNC catalysts, demonstrating the potential for implementation in large-scale sustainable CO₂ electrolyzers.

The preceding example relates to a specific example of catalyzing CO₂ to ethylene reactions, but the same principles are more broadly applicable to other reactions, other catalysts and/or other catalyst-electrode geometries, with the common element in all cases being a tandem catalyst integrated with a gas diffusion electrode. Thus, more generally, the tandem catalyst comprises 1) copper, or a copper-based binary or ternary alloy, and 2) a metal center coordinated to a) nitrogen-doped carbon (NC) or b) a NC-containing macrocyclic organic compound.

The Cu-based binary or ternary alloy has the form Cu—X—Y, where X, Y are transition, or post-transition metals, such as Ag, Zn, Al, Sn, etc. The Cu or Cu-based alloys can be in the form of a nanostructure, such as nanoparticles, nanocubes, nanotubes, nanoflowers, nanorods, nanoplates, etc.

The metal center coordinated to the nitrogen-doped carbon (NC) can be a transition or post-transition metal, such as such as Ag, Zn, Al, Sn, etc. Examples include CoNC, FeNC, ZnNC, AgNC. The metal center can be coordinated to any NC-containing macrocyclic organic compounds, such as porphyrins, phthalocyanines, etc. with modified ligands. The morphology of X—NC can be in the form of nanoflowers, nanotubes, nanocages, mesopores, macropores, nanofibers, nanospheres, etc.

Reactions that can be facilitated by the tandem catalyst include but are not limited to:
CO₂ to CO (carbon monoxide) to C₂H₄ (ethylene)
CO₂ to CO (carbon monoxide) to C₂H₅OH (ethanol)
CO₂ to CO (carbon monoxide) to acetate
CO₂ to CO (carbon monoxide) to C3+ (i.e., straight chain hydrocarbons with 3 or more carbons)

In one aspect, the invention provides a process for converting carbon dioxide into a carbon-based molecule, the process comprising: applying a working voltage to a tandem electrocatalyst integrated with a gas diffusion electrode; providing a vapor-fed flow of the carbon dioxide to the tandem electrocatalyst integrated with the gas diffusion electrode; catalyzing a direct-conversion reaction of the vapor-fed flow of the carbon dioxide to the carbon-based molecule using the tandem electrocatalyst integrated with the gas diffusion electrode.

In one specific implementation, the tandem electrocatalyst consists of copper and nickel-coordinated nitrogen-doped carbon (NiNC), and the carbon-based molecule is ethylene. The copper may be in the form of nanoparticles, nanocubes, nanotubes, nanoflowers, nanorods, or nanoplates.

In various other implementations, the tandem electrocatalyst is a nanostructure composed of 1) a copper-based binary or ternary alloy, and 2) a metal center coordinated to a) nitrogen-doped carbon (NC) or b) a NC-containing macrocyclic organic compound.

The copper-based binary or ternary alloy may be in the form Cu—X—Y, where each of X, Y is a transition or post-transition metal. For example, each of X, Y may be Ag, Zn, Al, or Sn. The copper-based binary or ternary alloy may be in the form of nanoparticles, nanocubes, nanotubes, nanoflowers, nanorods, or nanoplates.

The metal center may be composed of a transition or post-transition metal. For example, the metal center may be Fe, Co, Ni, Ag, Zn, Al, or Sn.

The macrocyclic organic compound may be porphyrins or phthalocyanines with modified ligands.

The metal center coordinated to nitrogen-doped carbon (NC) or to a NC-containing macrocyclic organic compound may be in the form of nanoflowers, nanotubes, nanocages, mesopores, macropores, nanofibers, nanospheres, or other nanostructure.

The carbon-based molecule may be ethylene, ethanol, acetate, or a straight chain hydrocarbon with at least three carbon atoms. The process may be implemented using a membrane electrode assembly electrolyzer or a flow electrolyte electrolyzer.

### BRIEF DESCRIPTION OF THE DRAWINGS

FIG. 1A is a schematic illustration of GDE-based Cu/NiNC tandem electrocatalysis for CO₂ reduction, according to an embodiment of the invention.

FIGS. 1B and 1C are scanning electron microscope (SEM) images of a uniform catalyst layer of tandem Cu/NiNC GDE, according to an embodiment of the invention.

FIG. 1D shows EDS elemental maps of Cu and Ni of the cross-section image in FIG. 1C.

FIG. 1E and FIG. 1F are x-ray photoelectron spectroscopy graphs of a.u. intensity vs binding energy, illustrating Cu⁰, Cu¹⁺, and Cu²⁺ oxidation states indicating the presence of Cu₂O.

FIG. 1G is an x-ray diffraction graph of a.u. intensity vs theta, showing the x-ray diffraction patterns of the evolution of crystalline structures of Cu and Cu/NiNC tandem electrodes before electrochemical reactions.

FIG. 2A is a Faradaic efficiency graph showing higher faradaic efficiency of ethylene (FE_{ethylene}) with the Cu/NiNC tandem electrode across all tested potentials compared to the Cu only electrode

FIG. 2B is a graph of partial current density of ethylene (j_{ethylene}) showing higher j_{ethylene} of the tandem electrode towards the formation of C₂H₄ compared to that of the Cu only electrode.

FIG. 2C is a graph of the C₂H₄/CO selectivity ratio obtained with Cu/NiNC and Cu electrodes.

FIG. 3A shows the CO₂ consumption rate towards the formation of C₂H₄, on Cu and Cu/NiNC tandem electrodes.

FIG. 3B shows a graph of the CO₂ consumption rate towards the formation of uncoupled CO, and partial current density towards CO on Cu and Cu/NiNC tandem electrodes.

FIG. 3C is a schematic diagram illustrating two possible CO₂ reduction pathways for C₂H₄ formation on the tandem catalyst surface on a gas diffusion layer.

FIG. 4A and FIG. 4D are 3D and top-down schematic views, respectively, of the gas-liquid interface in the simulation domain.

FIG. 4B and FIG. 4C are plots of concentrations of CO and P, respectively, when the flux applied to catalyst particles is J=1×10⁻⁶ kmol/m²s.

FIG. 4E and FIG. 4F are plots of dimensionless diffusive fluxes of CO and P, respectively.

FIG. 4G is a graph of the calculated area-averaged fluxes of CO from NiNC and higher-order products P through the gas-liquid interface.

FIG. 4H is a graph of the P/CO flux ratios of those fluxes as a function of the Cu₂O/NiNC volume ratio.

FIG. 5A is a schematic diagram illustrating a practical utilization of the tandem catalysis using the Cu/NiNC GDE as the cathode in a MEA electrolyzer.

FIG. 5B is a graph of faradaic efficiency and cell voltage of Cu and tandem Cu/NiNC gas diffusion electrodes for CO₂ reduction.

FIG. 5C is a graph of chemical energy efficiency of Cu and tandem Cu/NiNC gas diffusion electrodes.

FIG. 6 is a graph of x-ray diffraction patterns of Cu and Cu/NiNC GDEs before (pre) and after (post) electrochemical tests.

FIG. 7 is a schematic illustration of a vapor-fed CO₂ flow electrolyzer setup for vapor-fed CO₂ reduction using Cu/NiNC and Cu GDEs.

FIG. 8A, 8B, 8C are bar charts illustrating the distribution of gas phase products obtained with CuₓO gas diffusion electrodes with various catalyst loadings using 1 M KOH electrolyte for vapor-fed CO₂ reduction. (Yellow, purple, and orange bars indicate H₂, C₂H₄, and CO, respectively.)

FIG. 9 is a bar chart illustrating the potential dependent product selectivity evaluation of CO₂ reduction of NiNC GDE in the vapor-fed CO₂ flow electrolyzer.

FIG. 10A, 10B are cross-sectional SEM images of Cu GDE and Cu/NiNC GDE, respectively, used for electrochemical testing.

FIG. 11 is a bar chart illustrating Faradaic efficiency and partial current density of C₂H₄ obtained with the Cu GDE at various potentials.

FIG. 12A, 12B, 12C are bar charts showing product distributions obtained from Cu, Cu/NiNC-high, and Cu/NiNC-low GDEs, respectively.

FIG. 13A is a graph of Faradaic efficiency towards C₂H₄ obtained from Cu, Cu/NiNC-high, and Cu/NiNC-low GDEs, respectively.

FIG. 13B, 13C are graphs of partial current densities towards C₂H₄ and CO, respectively.

FIG. 13D is a graph of C₂H₄/CO selectivity ratio obtained with Cu and different tandem GDEs at various potentials.

FIG. 14A, 14B show pre-electrochemical SEM images of Cu GDE.

FIG. 14C, 14D show post-electrochemical SEM images of Cu GDE.

FIG. 14E, 14F show pre- and post-electrochemical SEM images of Cu/NiNC GDE.

FIG. 15 is a plot of cell voltage vs time, showing cell voltage stability of the optimized Cu/NiNC GDE.

FIG. 16 is a table showing catalytic performance of reported tandem catalysts in the literature.

### DETAILED DESCRIPTION

In embodiments of the invention, increased ethylene formation during vapor-fed carbon dioxide reduction is achieved by employing tandem electrocatalyst consisting of nickel-coordinated nitrogen-doped carbon and cuprous oxide, which act as carbon monoxide generator and coupler, respectively. Performance evaluation was conducted in both flow electrolyte and membrane electrode assembly electrolyzers to demonstrate the potential for large-scale and direct carbon dioxide gas conversion into value-added chemicals.

A preferred embodiment of the invention provides a unique tandem gas diffusion electrode (GDE) comprising cuprous oxide nanocubes and Ni-coordinated N-doped carbons (NiNC). Described herein is also the evaluation of tandem catalysis under direct CO₂ gas reduction by employing both vapor-fed flow electrolyte and membrane electrode assembly (MEA) electrolyzers. The Cu/NiNC-catalyst-loaded GDEs provide substantially increased mass transport that enables high product formation rates. Due to the different physicochemical properties of the two materials, we observed enhanced selectivity towards the formation of C₂H₄ during CO₂R while mitigating mixing of the two under CO₂ reduction conditions. Because NiNC is an excellent CO production catalyst, it significantly increases the local availability of CO near the Cu sites to promote increased C—C coupling. In fact, the tandem Cu/NiNC GDE exhibits significantly higher selectivity and production rate towards the formation of C₂H₄ at lower overpotentials compared to the Cu-only GDE in the vapor-fed flow electrolyzer. Additionally, resolved 3-dimensional continuum simulations are performed to demonstrate the qualitative enhancement of C₂₊ product formations on GDEs with varying ratios of Cu and NiNC, showing that the increased internal CO concentration with higher loadings of NiNC leads to an increased C₂₊ flux. Lastly, the tandem GDE is evaluated in an MEA electrolyzer, demonstrating a very respectable energy efficiency towards C₂H₄, among the highest reported for direct CO₂-to-ethylene conversion in the literature.

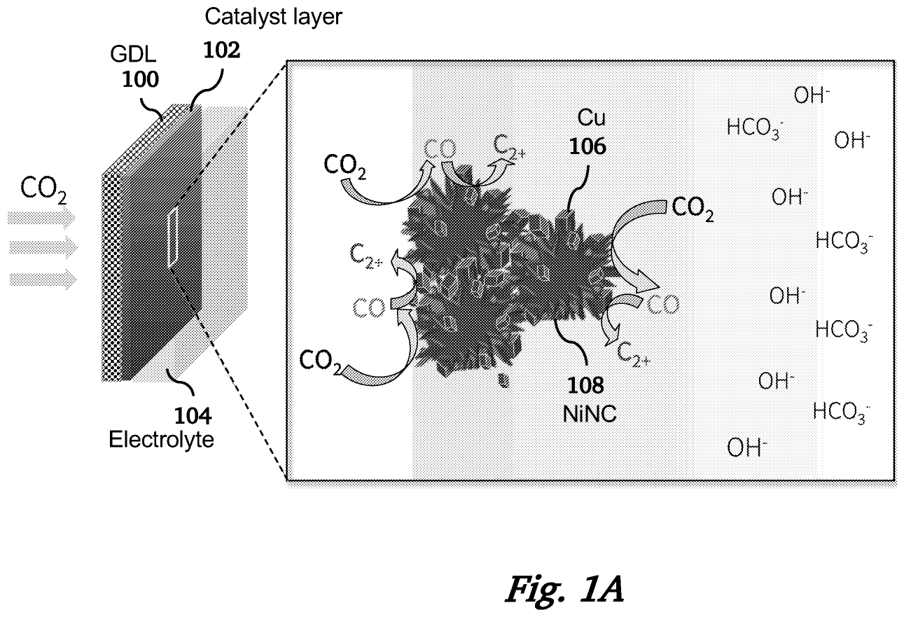

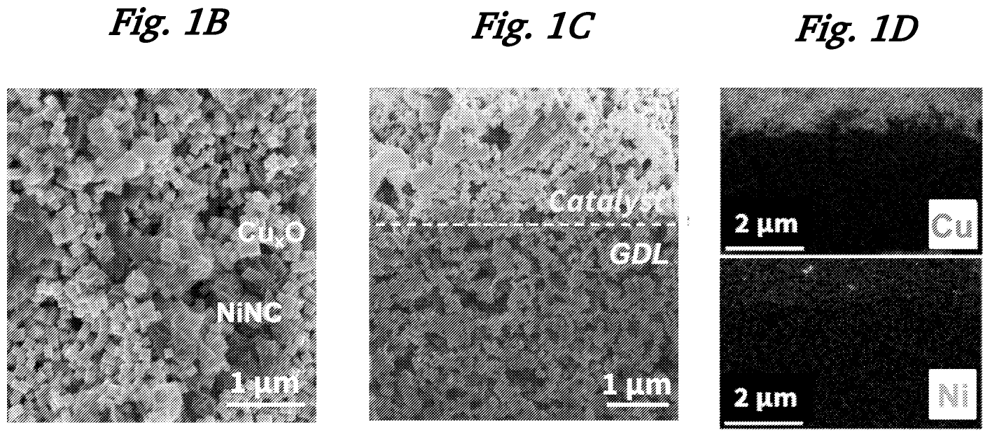

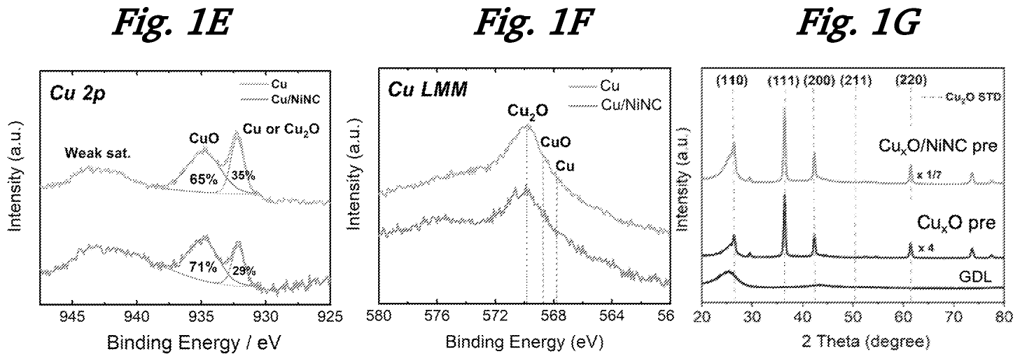

FIG. 1A is a schematic illustration of a GDE-based Cu/NiNC tandem electrocatalysis for CO₂ reduction, according to an embodiment of the invention. CO₂ flows to contact gas diffusion layer 100 which has a catalyst layer 102 on an opposite surface where there is an electrolyte 104. The tandem electrocatalysis involves one Cu-based catalyst 106 and one CO producer 108 for enhanced multi-carbon productions. Here, NiNC of 200 nm in diameter is applied as a CO producer 108 which effectively converts CO₂ to CO, and then CO further reacts with Cu catalysts 106 for enhanced C₂₊ product formation in lower overpotentials. Also, the cuprous oxide (CuₓO) nanocube, with a 30 nm diameter is prepared as the catalyst which is expected to be reduced to a metallic copper (Cu) nanocube as the active oxidation state under the applied cathodic potentials during the CO₂ reduction reaction. The active catalyst layer 102 is composed of two different materials, Cu nanocube and NiNC (Cu/NiNC), mixed and then loaded on the gas diffusion layer (GDL) 100 as the cathode in the CO₂ vapor-fed flow cell setup. In the tandem reaction scheme, the increased local CO availability leads to increased C—C coupling that is used for ethylene production. Specifically, NiNCs act as the CO generator to increase local CO concentration, while Cu acts as the CO promoter to further convert CO to C₂₊. NiNC has superior catalytic performance for converting CO₂ to CO in the neutral electrolyte (>90% FE_{co}) due to its well-dispersed single-atom Ni sites on the nitrogen-doped carbon scaffolds. In general, high-surface area Cu catalysts show high overall activity for producing ethylene, ethanol, n-propanol, n-butanol, and traces of acetate and ethane, at fairly low overpotentials.

A uniform catalyst layer of Cu/NiNC GDE is composed of as-prepared CuₓO nanocubes and NiNCs produced by thorough mixing during GDE fabrication as shown from top view in the SEM image in FIG. 1B. Similarly, FIG. 1C is the cross-section view SEM image of the tandem GDE showing uniformly distributed CuₓO nanocubes and NiNCs throughout the thickness of the catalyst layer. A small particle size of cuprous oxide nanocubes is a key to their incorporation into the interparticle spacings of the much larger NiNC, accomplished by a simple sonication during electrode fabrication, resulting in a homogeneously mixed catalyst layer that can facilitate CO to readily transport over to neighboring Cu.

FIG. 1D shows EDS elemental maps of Cu and Ni of the cross-section image in FIG. 1C. FIG. 1E shows Cu 2p, and FIG. 1F shows Cu LMM XPS spectra of Cu and Cu/NiNC GDEs, and FIG. 1G shows XRD patterns of pristine Cu and Cu/NiNC GDEs before electrochemical tests.

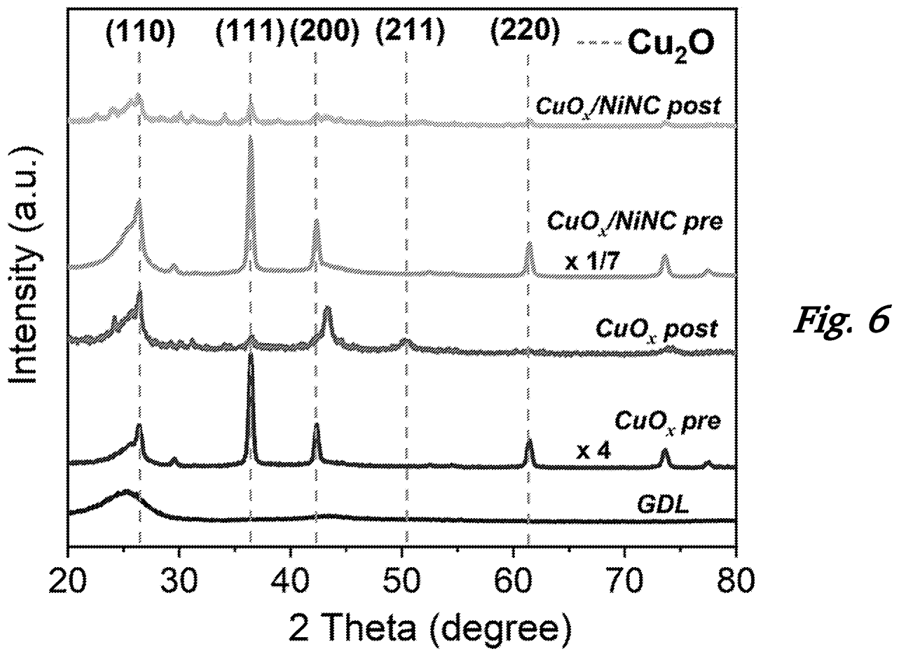

The energy-dispersive spectroscopy (EDS) elemental maps of Cu and Ni shown in FIG. 1D also corroborate uniform distributions of cuprous oxide nanocubes and NiNC throughout the thickness. Ex situ measurements were conducted to measure the oxidation state of Cu present in the tandem GDE. The Cu 2p XPS shows peaks that correspond to Cu⁰, Cu¹⁺, and Cu²⁺ oxidation states with a weak satellite at 941-945 eV, which is a strong indication of the presence of Cu₂O, the target phase during the synthesis of cuprous oxide nanocubes as shown in FIG. 1E. This is clearer in the XPS of the Cu LLM region where a strong signal corresponding to Cu₂O is observed while CuO and Cu peaks are not observed as shown in FIG. 1F. Interestingly, the Ni XPS signal could not be clearly characterized, most likely due to its low concentration in the catalyst layer, consistent with the results for similar single-site catalysts reported in the literatures. In addition, the homogeneous mixing of NiNC with cuprous oxide nanocubes could have likely hindered the detection of Ni 2p XPS signal owing to some NiNC surfaces being physically blocked by Cu. Furthermore, FIG. 1G shows the ex situ XRD patterns of the evolution of crystalline structures of Cu and Cu/NiNC tandem electrodes before (FIG. 1G) and after electrochemical reactions (FIG. 6). In both Cu and Cu/NiNC electrodes, the (110), (111), and (200) plane peaks reveal the signatures of Cu₂O nanocubes and abroad carbon signal around 25° attributed to the underlying GDL substrate. According to the prior reports, cuprous oxides or copper oxides have been demonstrated to reduce to Cu metal under reducing conditions in the presence of CO₂ or CO. Specifically, no surface oxides are detected on the electrochemically reduced cuprous oxide surfaces at potentials negative of −0.4 V vs. RHE as revealed by X-ray absorption spectroscopy (XAS). Thus, in this work, the as-synthesized cuprous oxide nanocubes are assumed to be fully reduced to metallic Cu nanocube under the reduction conditions where tandem effects are observed.

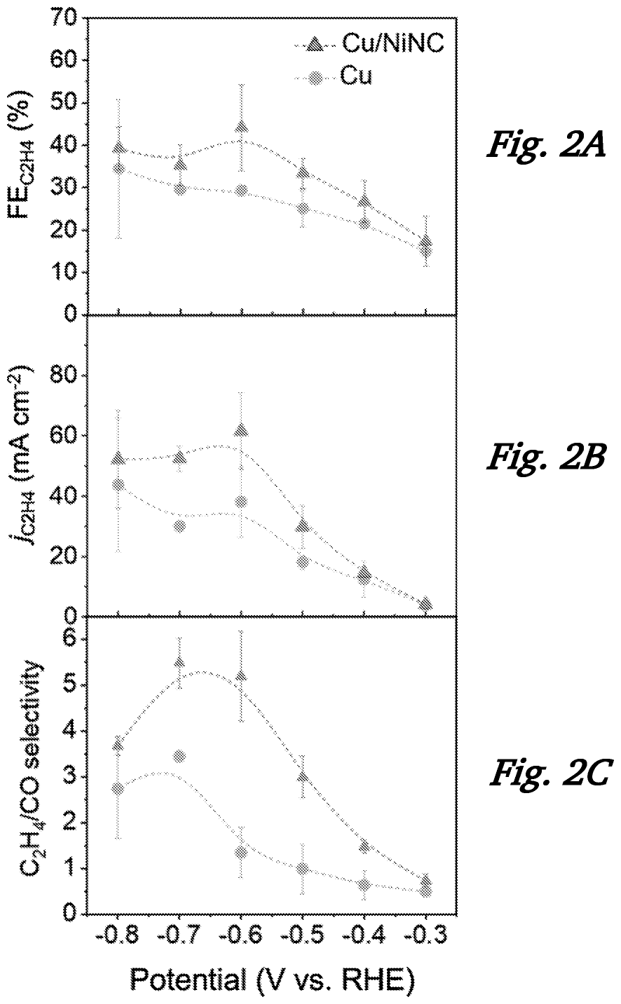

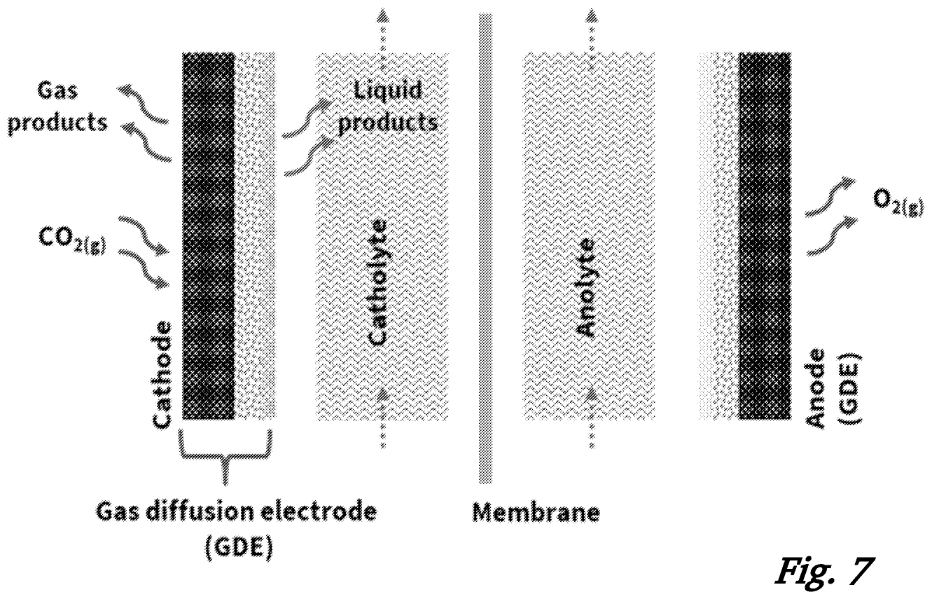

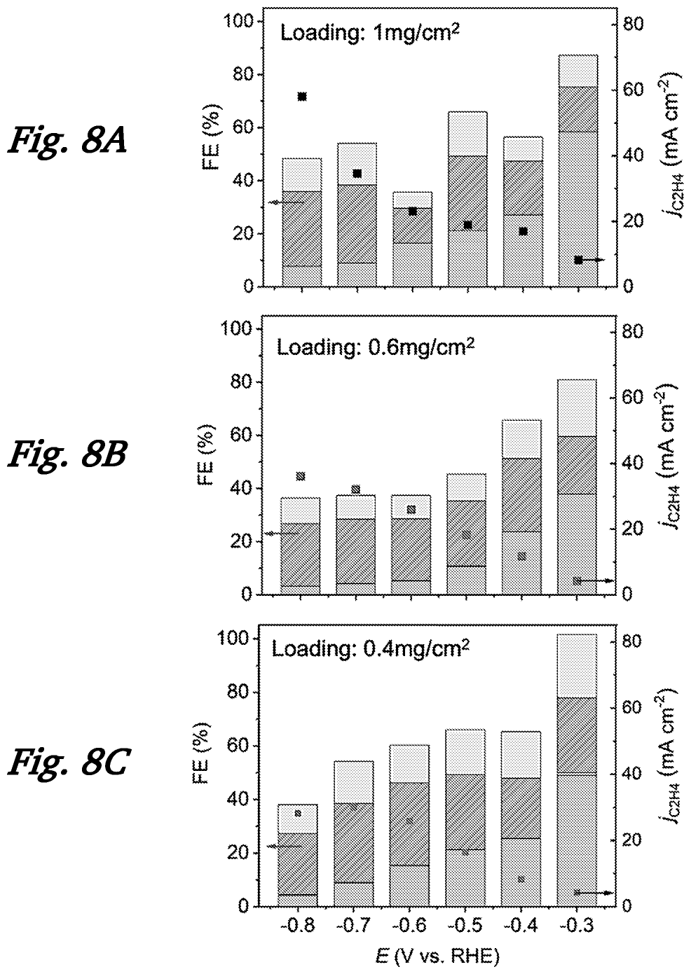

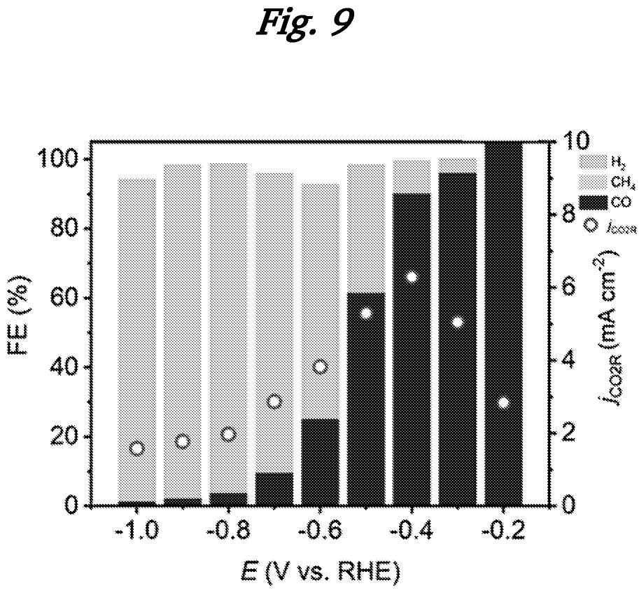

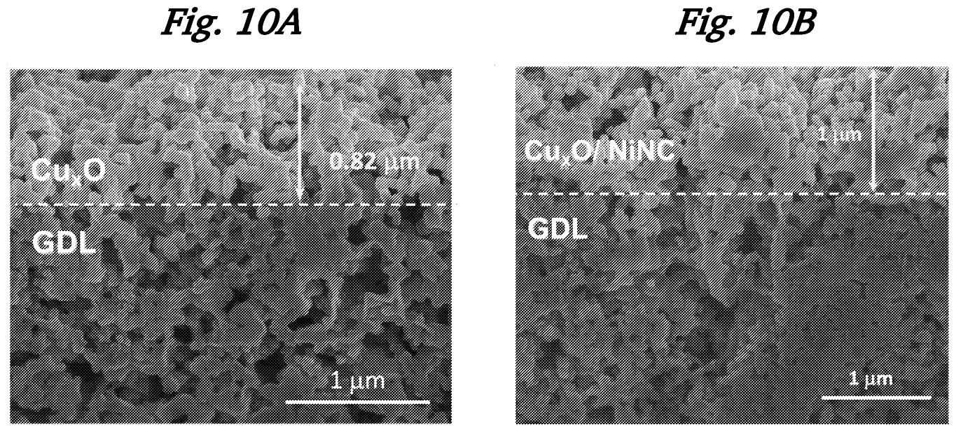

The electrocatalytic performance of Cu/NiNC and Cu GDEs are evaluated in a vapor-fed CO₂ flow electrolyzer using 1 M KOH as the electrolyte (FIG. 7), revealing potential-dependent selectivity of products produced such as CO, C₂H₄, and C₂H₅OH (FIG. 8A, 8B, 8C). Specifically, higher ethylene FEs are observed with the Cu/NiNC tandem electrode across all tested potentials compared to the Cu only electrode as shown in the Faradaic efficiency graph of FIG. 2A. Specifically, Cu/NiNC shows FEs for C₂H₄ increase concomitantly with the overpotential, reaching a peak of an average 45% at −0.6 V vs. RHE. In comparison, the Cu electrode reaches an average peak FE of 35% for C₂H₄ at a more negative potential of −0.8V vs. RHE. The high selectivity towards C₂H₄ in the potential range of −0.5 to −0.7 V vs. RHE achieved with the tandem electrode is attributed to the increased CO generated by NiNC, which is confirmed to be highly CO producing in the potential range of −0.2 to −0.6 V vs. RHE (FIG. 9). The increased local CO availability near Cu facilitates C—C coupling due to the proximity achieved between the two catalyst components from the robust mixing performed during GDE fabrication. The cross-section SEM images show a similar catalyst layer thickness of approximately 1 μm for both Cu and Cu/NiNC electrodes at the nominal catalyst loading of 1 mg cm⁻², corroborating that the enhanced C₂H₄ selectivity is likely due to the tandem effect rather than improved mass transport (FIGS. 10A, 10B). In particular, at low overpotentials, a relatively high range of C₂H₄ FE of 20 to 30% is observed with the tandem electrode at the potentials ranging from −0.3 to −0.4 V vs. RHE compared to the Cu electrode (15 to 20%) and other Cu based GDEs reported in the literature. This is indicative of the tandem catalysis effect occurring particularly at the low overpotentials where NiNC produces CO with >80% FE, allowing for an early onset of C—C coupling.

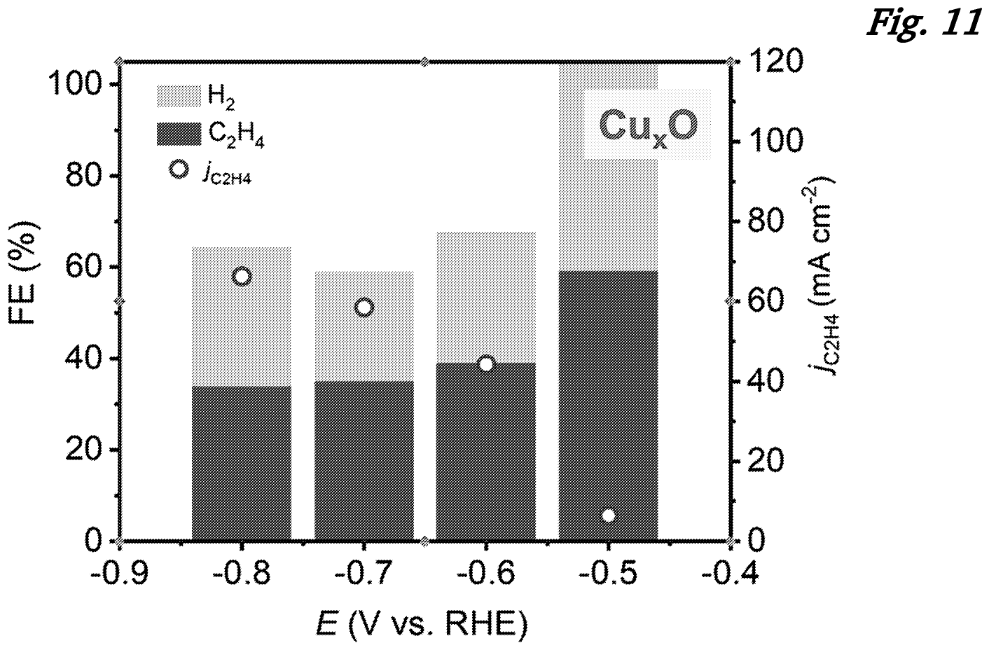

In addition to the higher FEs, the tandem electrode is also found to exhibit higher partial current density (PCD_{geo}, current normalized by the geometric area of the electrode) towards the formation of C₂H₄ at all tested potentials as shown in FIG. 2B. In particular, the tandem electrode shows the highest C₂H₄ PCD_{geo} of 62 mA cm⁻² at −0.6 V vs. RHE, which is more than 60% higher than the C₂H₄ PCD_{geo} of Cu (38 mA cm⁻²) at the same potential. The C₂H₄ PCDs for both electrodes' plateau at more negative potentials likely due to the onset of mass transport limitations of CO₂ in the catalyst layer. The effect of CO generation from NiNC on tandem catalysis is demonstrated by performing CO reduction on the Cu electrode, which resulted in similar C₂H₄ FEs and PCDs shown above for the tandem electrode under CO₂ reduction (FIG. 11). To emphasize the utilization of the generated CO and the effectiveness of C—C coupling, we use the C₂H₄/CO selectivity ratio as an indicator to show the electrode's ability to convert local CO into C₂H₄.

FIG. 2C is a graph of the C₂H₄/CO selectivity ratio obtained with Cu/NiNC and Cu electrodes at various potentials tested in 1 M KOH electrolyte. As shown in FIG. 2C, both the Cu/NiNC and Cu electrodes generally show an increasing trend in the C₂H₄/CO ratio with increasing overpotential. However, it is observed to be substantially accelerated for the tandem electrode particularly at the moderate overpotentials, reaching a maximum C₂H₄/CO of 5.5 at −0.7 V. At the same potential, the Cu electrode shows a maximum C₂H₄/CO ratio of only 3.5. This dramatic increase in the selectivity ratio is attributed to the C—C coupling that is facilitated by Cu using the additional local CO that is generated by NiNC, highlighting the high utilization of CO which leads to relatively higher C₂H₄ selectivity.

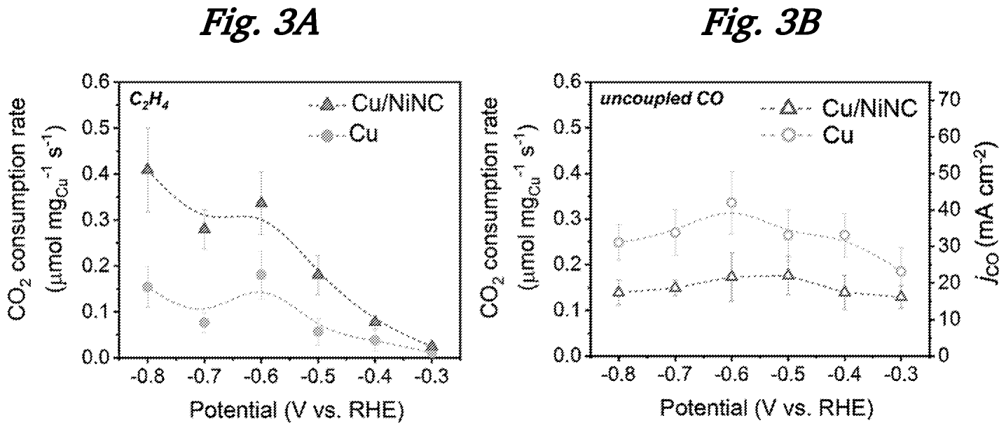

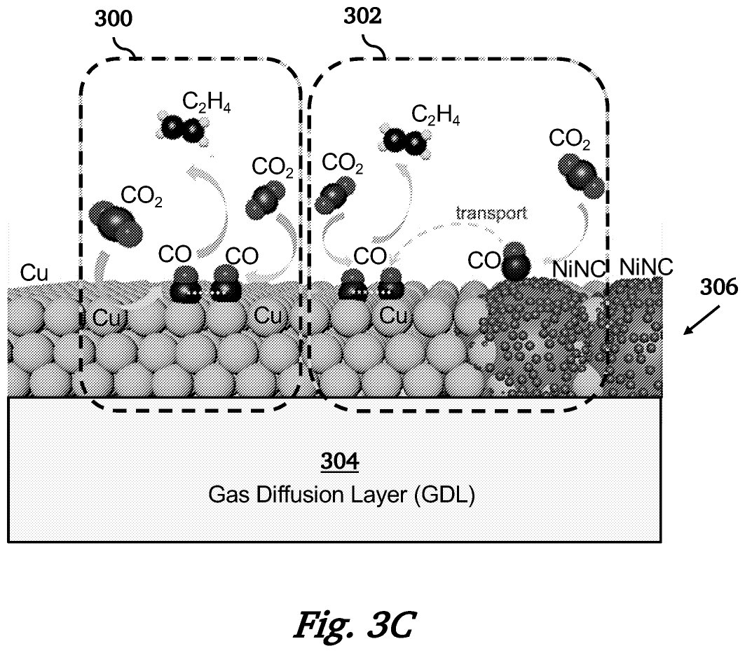

In addition to the FEs and PCDs discussed above, the tandem effect is demonstrated in terms of Cu-mass-normalized CO₂ consumption rate towards C₂H₄ and uncoupled CO as shown in FIG. 3A and FIG. 3B, respectively. FIG. 3A shows the CO₂ consumption rate towards the formation of C₂H₄ (left y-axis), and partial current density towards CO (right y-axis) produced on Cu and Cu/NiNC tandem electrodes at various tested potentials. FIG. 3B shows a similar graph of the CO₂ consumption rate towards the formation of uncoupled CO (left y-axis), and partial current density towards CO (right y-axis). The tandem electrode shows increased CO₂ consumption rate towards C₂H₄ formation at all potentials tested, reaching a maximum CO₂ consumption rate of 0.4 μmol mg_{Cu}⁻¹ s⁻¹ at −0.8 V vs. RHE, compared to the Cu electrode reaching only 0.15 μmol mg_{Cu}⁻¹s⁻¹ at the same potential. The increase in the CO₂ consumption rate towards producing C₂H₄ with increasing overpotential is also observed to be much faster with the tandem electrode than the Cu electrode. Interestingly, the CO₂ consumption towards the formation of uncoupled CO measured with the tandem electrode at all tested potentials are much lower than those measured with the Cu electrode, likely due to the majority of CO near the Cu surface that have further C—C coupling to form ethylene. This could be explained by an additional C—C coupling mechanism that may be unique to our tandem electrode system operating in vapor-fed environments, which could be occurring in parallel to the ‘conventional’ C—C coupling mechanism, which is discussed in the next paragraph. In terms of CO activity as shown in FIG. 3B, the Cu/NiNC electrode leads to much lower CO PCD compared to Cu at all tested potentials which is likely due to the increased consumption of CO through C—C coupling. This again bolsters the earlier discussion that a high local CO availability is needed in the vicinity of Cu, which NiNC is able to provide, in order for tandem catalysis to occur efficiently and accelerate the formation of C₂H₄.

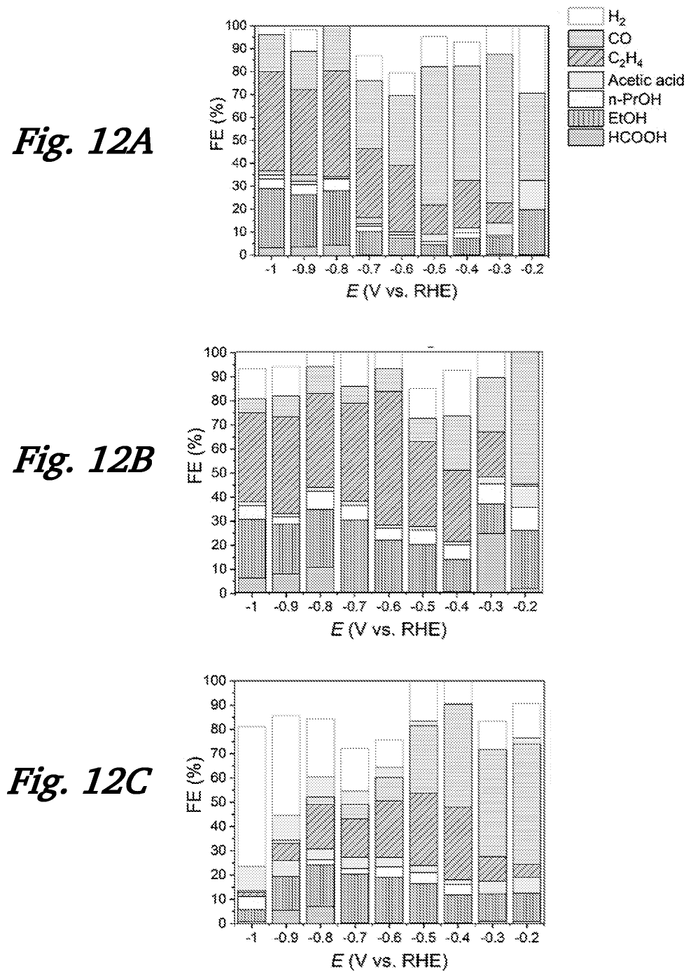

In attempts to maximize the local CO availability, tandem GDEs with varying ratios of Cu and NiNC are fabricated and evaluated (FIG. 12A, 12B, 12C, 13). Interestingly, tandem GDEs with 4× increased NiNC loading (Cu/NiNC-low) with a fixed Cu loading results in lower C₂H₄FE across the entire tested potential range compared to the final tandem GDE. This suggests that there exists an optimal CO₂:CO ratio in the gas stream that is needed for achieving the maximized tandem effect. For instance, an earlier study reported that CO₂/CO co-feeds with a moderate CO partial pressure (i.e., CO₂:CO=1:1) result in the enhancements on the C₂H₄ production rate compared to pure CO₂ and CO feeds. Similarly, in terms of C₂H₄ PCD, tandem GDEs with increased NiNC loadings (Cu/NiNC-high) show decreased C₂H₄ PCDs due to the imbalance of CO and CO₂, which suggests that the CO partial pressure is important for facilitating the tandem reaction mechanisms.

FIG. 3C is a schematic diagram illustrating two possible CO₂ reduction pathways for C₂H₄ formation on the tandem catalyst surface 306, which is fabricated on a gas diffusion layer 304. In a first pathway 300, Cu facilitates all reaction steps. In a second pathway 302, CO produced on NiNC a few bond lengths away is transported to the Cu surface for C—C coupling.

C—C bond formation on pure Cu catalysts has been a major area of investigation both experimentally and computationally. Pathway 300 through CO—CO coupling can occur on all of our studied catalysts, including pure Cu and tandem Cu/NiNC. It is well known that establishing a higher local concentration of CO at the interface can expedite the C—C coupling process. It is here where our vapor-fed, tandem catalyst system can result in greater efficacy. Specifically, the NiNC catalyst generates CO nearly exclusively near the Cu surface, which makes use of the greater CO concentration to produce C₂H₄, as depicted in pathway 302. Mechanistically, Langmuir-Hinshelwood (LH) and Eley-Rideal (ER) pathways have been proposed. Generally, it is believed that Cu favors surface adsorbed CO to facilitate CO—CO coupling, either forming OC—CO* or OC—CO*, through the LH reaction pathway. However, there is likely a competitive adsorption of CO₂ and CO on Cu surfaces during reaction, which can potentially impede coupling between two neighboring CO molecules. On the other hand, the ER reaction pathway allows for C—C coupling between an adsorbed CO and a solvated CO at the outer Helmholtz layer, avoiding competition for adsorption sites for CO intermediates. While our results cannot elucidate which of these two is dominant, it is clear that the local concentrations of CO at the interface can improve the kinetics of C—C coupling. Additionally, the vapor-fed reaction environment from using GDEs in this work circumvents the need to co-feed CO as the solvated CO is sufficiently generated from CO₂R on NiNC. A possible bifunctional mechanism involving both Cu and Ni catalyst sites cannot be completely disregarded either, however, further investigation through in-situ electrochemical probing would help identify reaction intermediates and mechanisms at play. Below, we present computational modeling that reveals increased transport of CO to the Cu surface in the tandem system compared to the Cu only system.

To further elucidate the underlying mechanism of the tandem catalysis process, we perform mass transfer simulations using STAR-CCM+ with varying ratios of Cu and NiNC to examine the CO₂RR product distributions in the microenvironment near the catalyst surfaces. Here, we study the flux of two species, 1) CO and 2) higher-order products, denoted as “P”, on a model system designed to elucidate potential mass transfer mechanisms involved the tandem system.

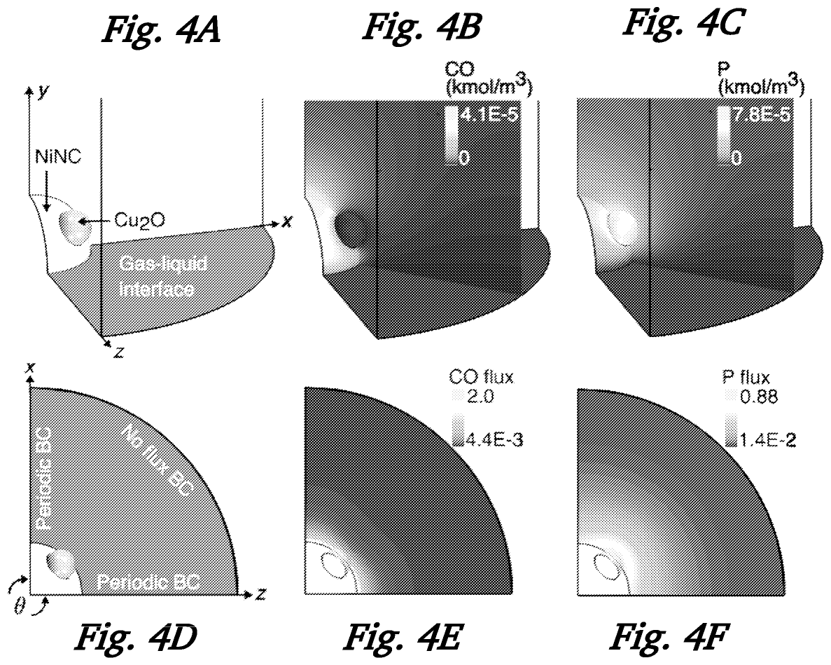

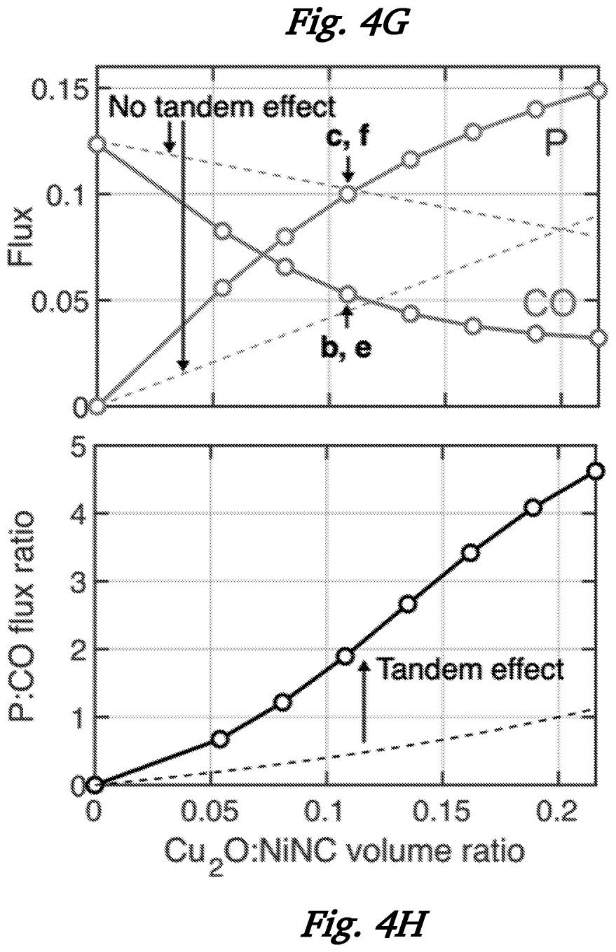

FIG. 4A is a 3D schematic of the simulation domain. FIG. 4D is a top-down schematic view of the gas-liquid interface in the simulation domain. Briefly, a single NiNC particle is represented as a hemisphere sitting on the gas-liquid interface, and the Cu particles are represented as smaller hemispheres on the NiNC surface.

FIG. 4B and FIG. 4C are plots of concentrations of CO and P, respectively, when the flux applied to catalyst particles is J=1×10⁻⁶ kmol/m²s. FIG. 4E and FIG. 4F are plots of dimensionless diffusive fluxes of CO and P, respectively. These figures show the particular case when the angle (θ) of the simulation domain is 90 degrees, i.e., four Cu₂O particles are considered. FIG. 4G is a graph of the calculated area-averaged fluxes of CO from NiNC and higher-order products P through the gas-liquid interface. FIG. 4H is a graph of the ratios of those fluxes as a function of the Cu₂O/NiNC volume ratio. Open circular symbols with solid lines show simulation results, and dashed lines show the results when the tandem effect is inactive.

By simulating only a periodic sector of azimuth angle θ with a single Cu particle, the number of Cu particles is then varied by changing θ from 0 to 2π—in other words, there are 2π/θ Cu particles. In this model, the NiNC is assumed to produce only CO with a flux J, and the Cu is assumed to be perfectly adsorbing for CO. Additionally, we assume that the flux of P from Cu has two contributions: (1) P is produced with a flux equal to the rate of consumption of CO, i.e. the “tandem effect” (Cu reacts with CO generated from NiNC to form P) and (2) P is produced with a flux J, since Cu also produces CO, and we assume that this is immediately converted to P. FIG. 4G shows averaged fluxes of CO and P through the gas liquid interface as a function of the Cu/NiNC volume ratio, nondimensionalized by J. The solid and dashed lines in FIG. 4G show fluxes when the tandem effect—effect (1) above—is turned on and off, respectively. When the tandem effect is off, the flux through the gas liquid interface is simply based on the flux of CO from NiNC and the flux of P from Cu via mass conservation; the fluxes of CO and P decrease and increase, respectively, due to the geometric constraint that the available active surface area of NiNC decreases as the number of Cu particles increases. When the tandem effect is active, and the Cu particle is converting the CO produced by the NiNC into product P, we see an enhancement of the flux of P through the gas-liquid interface and a corresponding decrease in the flux of CO. This implies that the tandem effect causes a portion of the CO produced to be converted to P through C—C coupling and illustrates how the catalyst composition can be tuned to achieve the desired product selectivity.

In FIG. 4H, this same data is plotted as a ratio, highlighting the extent that the tandem effect enhances conversion as the volume ratio increases. These simulation results corresponded to our experimental results in which higher Cu/NiNC ratios show the highest C₂H₄FE as well as C₂H₄ PCD. To further probe the microenvironment near the catalyst, in FIG. 4B and FIG. 4C, the concentration fields of CO and P are plotted for an example simulation. The CO concentration is fully depleted on the Cu surface, leading to an accumulation of P concentration, due to the conversion of CO to C₂₊ products via C—C coupling on Cu; in contrast, the CO concentration is the highest and the P concentration is diminished on the NiNC particle, where CO is produced. In FIG. 4E and FIG. 4F, the local fluxes of CO and P on the gas-liquid interface are shown. Both fluxes are maximized on the gas-liquid interface right next to the catalyst particle, in other words, closest to where the species are produced; mass transfer into the gas stream is thus maximized here.

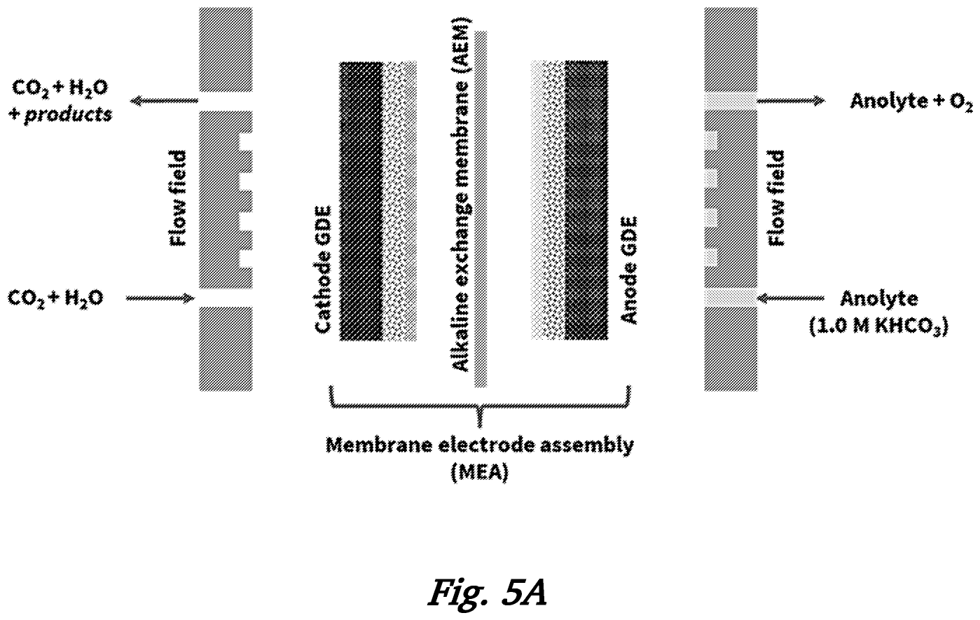

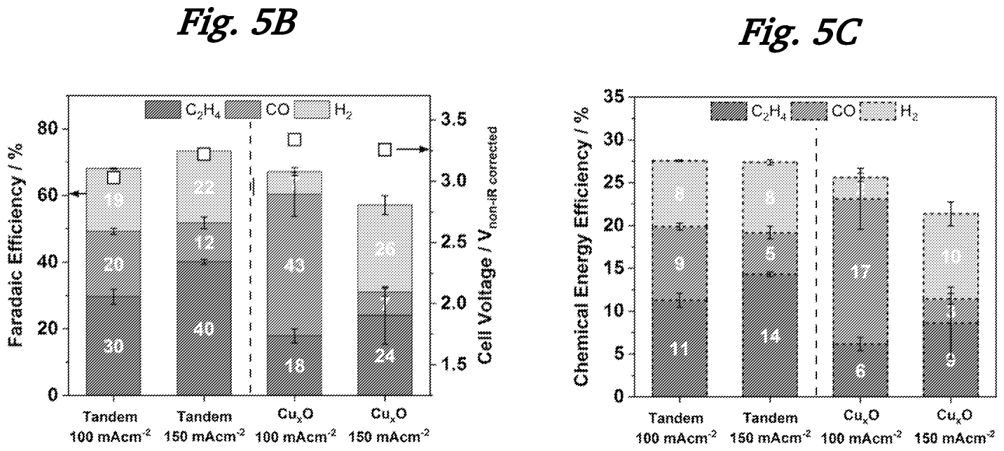

To further demonstrate the practical utilization of the tandem catalysis, the performance of the Cu/NiNC GDE is evaluated as the cathode in a MEA electrolyzer as shown in FIG. 5A which is a schematic illustration of the employed MEA cell setup. MEA performance evaluation of Cu and tandem Cu/NiNC gas diffusion electrodes for CO₂ reduction is illustrated in FIG. 5B which is a graph of faradaic efficiency, and FIG. 5C which is a graph of chemical energy efficiency tested with 1.0 M KHCO₃ anolyte and 50 sccm CO₂.

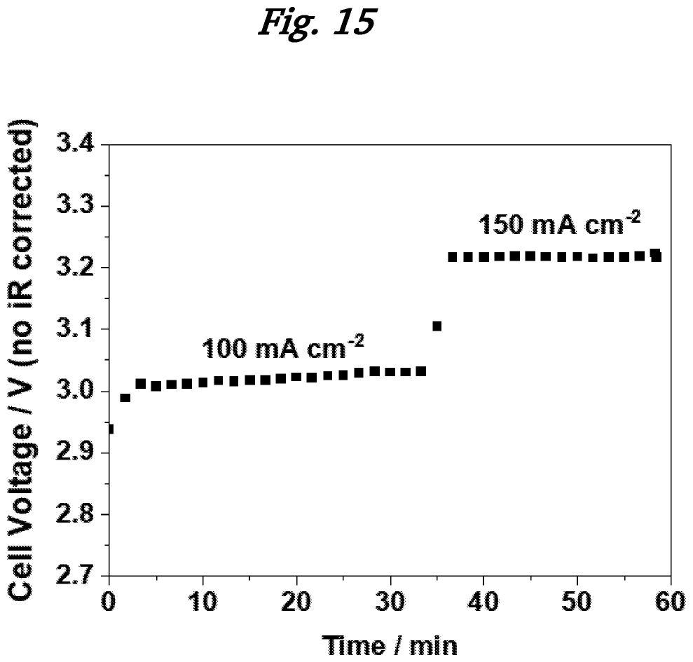

Unlike in the vapor-fed flow electrolyzer demonstrated in the above section, the MEA uses a solid polymer-based membrane as the electrolyte, which is compressed between the cathode and the anode, which helps to improve energy efficiency with significantly lower single-cell voltages for potential commercial CO₂ electrolyzer applications. At the applied current densities of 100 to 150 mA cm⁻², the Cu/NiNC tandem electrode in the MEA shows 3.0 and 3.2 V (non-iR compensated), respectively, with negligible voltage degradation over a total of one hour testing (FIG. 15). With increasing current density, C₂H₄ FE is observed to increase from 30 to 40%, while the CO FE decreases from 20 to 12%. The increasing C₂H₄ and decreasing CO selectivity trends with current density are attributed to the tandem effect in which the local CO near the Cu surface under cathodic potentials readily undergoes C—C coupling. In comparison to the tandem electrode, the non-tandem Cu electrode tested in the identical MEA conditions show relatively lower C₂H₄ FEs of 18 and 24% at and 100 and 150 mA cm⁻², respectively. Interesting, the CO FE of 43% obtained at 100 mA cm⁻² with the Cu electrode was relatively higher than that of the tandem electrode, while 7% obtained at 150 mA cm⁻² was relatively lower. This decrease in the CO selectivity with increased current density observed with the Cu electrode is likely due the specific microenvironment formed at the active interface of an MEA that is different from that of a flow electrolyte cell. The performance metrics demonstrated by the tandem MEA are competitive compared to recently published results. In particular, the single-cell voltage of 3.2 V obtained at 150 mA cm-z in this study is significantly lower compared to the reported voltages which range from 3.6 to 3.9 V for C₂H₄ producing MEA-based CO₂ electrolyzers. In terms of energy efficiency (EE), which is one of the key performance metrics related to the total energy that is required to drive the electrolyzer, the tandem MEA resulted in the C₂H₄EE of 10.7% and 14.5% at the applied current densities of 100 and 150 mA cm⁻², respectively. These results are among the highest based on EE values reported in the literature for the direct CO₂-to-ethylene conversion, while the Cu MEA has resulted in C₂H₄ EE of 13.4%, highlighting the practical feasibility of MEA-based tandem CO₂ electrolyzers for potential large-scale applications.

In summary, we have successfully demonstrated a highly selective ethylene formation at low overpotentials using a non-alloy tandem catalyst made from cuprous oxide nanocubes combined with nickel-containing nitrogen-doped carbon (NiNC) in a vapor-fed CO₂ electrolysis system. Based on the product analysis, a significantly enhanced Faradaic efficiency of ethylene is achieved, resulting in 55% FE at −0.6 V vs. RHE compared to 30% obtained with the electrode made from only cuprous oxide. Additionally, a 4.5 times higher C₂H₄/CO selectivity ratio was observed, demonstrating a higher utilization of CO. Through varying the Cu and NiNC ratio, ethylene selectivity is maximized, which is attributed to the increased local CO coverage near the Cu surface by CO that is readily produced by NiNC. As a result, CO utilization was improved substantially for C—C coupling, as indicated by low CO partial current densities in the potential range where high ethylene partial current densities are observed. To corroborate experimental observations, 3-dimensional continuum simulations were performed, verifying that CO generated from NiNC increases the CO flux to the Cu surfaces, thereby increasing CO concentration to for greater production of multi-carbon products. Furthermore, we demonstrated the practical feasibility of the tandem electrode performing CO₂ conversion in a membrane electrode assembly (MEA), resulting in ethylene FE of 40% at 3.2 V cell voltage compared to 36% obtained with the Cu only electrode. Both the experimental and computational results provided in this study highlight the advantages of a tandem catalysis scheme based on Cu combined with a non-metallic CO promoter, NiNC, for the formation of ethylene. Tandem approaches can help accelerate the implementation of large-scale CO₂ electrolyzers in the energy grids.

### Synthesis of Nickel-Coordinated Nitrogen-Doped Carbon (NiNC) Powder

The synthesis of polyacrylonitrile (PACN)-based catalysts may use procedures in published literature. In one example, the synthesis of polymer particle, the polymerization reaction of 2 mL acrylonitrile (2 mL) is initialized by 2 mg azobisisobutyronitrile and Ni(NO₃)₂·6H₂O in 2 mL acetone at 70° C. under N₂ atmosphere for 12 h. Then the solution was vacuum dried and the powdered Ni-PACN was collected. The generated powder was heated in air at 230° C. for 2 h at a heating rate of 0.1° C./min. After that, the powder is further heated in N₂ at 900° C. at a heating rate of 5° C./min. The final product is black Ni-PACN catalyst.

### Synthesis of Cuprous Oxide Nanocubes

In another example, the synthesis process of 30 nm Cu₂O nanocubes is performed using slight modifications to a published procedure. Typically, 1.152 g SDS (sodium dodecyl sulfate) powder is added to 181.2 mL water in a vial. After the solution is well mixed, 2 mL 1 M Cu₂SO₄ is added into the continuously stirring SDS solution. 0.8 mL 1 M NaOH is added to solution and consequently, Cu(OH)₂ is generated. A 16 mL 0.2 M sodium ascorbate solution is quickly injected into the Cu(OH)₂ solution. We allowed the solution to stir for 5 min, followed by aging for 10 minutes (no stirring) as color turns from light yellow to bright yellow. The solution is then centrifuged at 12000 RPM for 10 min and the resulting orange yellow powder is collected. The precipitate is washed twice with 20 mL 1:1 volume ratio of ethanol and water.

### Preparation of Tandem Catalyst Layer Loaded Gas Diffusion Electrode (GDE)

To prepare tandem catalyst layer with different weight ratio (1:0.5, 1:1 and 1:2), 1.87 mg Cu₂O powder and different amount of Ni-PACN (0.935 mg, 1.87 mg, and 3.74 mg) with 4 ul Nafion (5 wt %) solution were dispersed in 1:1 H₂O:EtOH solution. The solution is sonicated for 1 h. The solution was spray-coated onto a gas diffusion layer (1.3×2.5 cm², Sigracet 39BC) which is heated at 70° C. Finally, the catalyst layer is annealed in the oven to evaporate remaining solvent.

### Electrochemical Measurements of GDE in Flow Electrolyte Cell

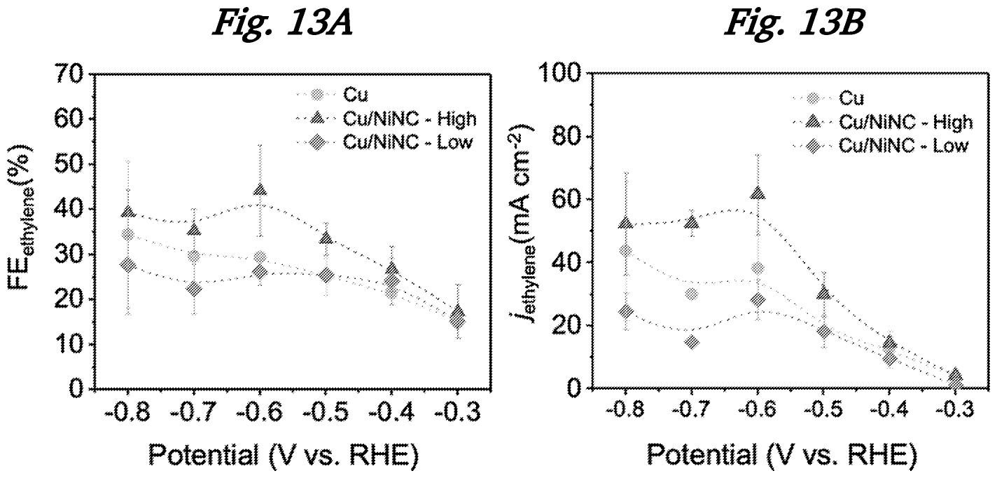

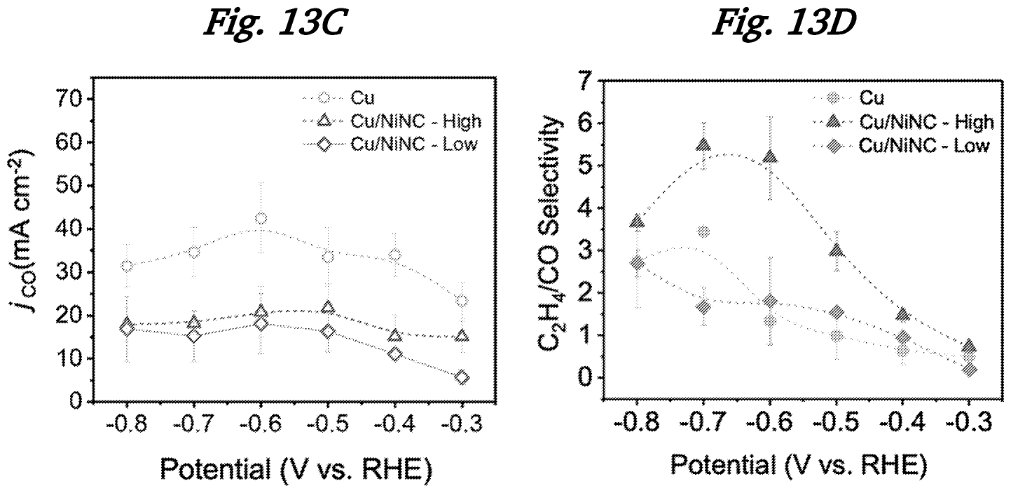

Catalyst coated electrodes were tested in a custom-built 3-compartment cell, in which a third chamber was added behind the typical catholyte chamber of the two-compartment electrochemical cell reported previously as shown in FIG. 13A, 13B, 13C, 13D. The working and counter electrode areas are 1 cm², respectively. CO₂ was continuously flowed through this third chamber to provide a vapor-phase feed to the prepared gas diffusion electrodes. Both the working and counter electrode electrolyte compartments were filled with 1M potassium hydroxide (KOH) as the catholyte for experiments at pH 14 and the vapor-fed 3^{rd} compartment were fed with CO₂ (20 sccm). IrOₓ GDE was used as a counter electrode, a leakless Ag/AgCl electrode (ET072-1, eDAQ) as the reference electrode. An anion exchange membrane (AEM) was a Fumasep FAA-3-50 placed between the two electrolyte-containing chambers for alkaline environments and a Selemion AMV was placed for neutral environments. Catalysts were tested using chronoamperometric (CA) measurements at defined electrochemical potentials which were corrected for 85% of the uncompensated resistance between the reference electrode and working electrode using built-in functions of the potentiostat (Biologic, VMP-300). Scan rates were set to 50 mVs⁻¹. Gas flow rates of the flow controller (gas inlet) and flow meter (gas outlet) were recorded by the external device inputs of the potentiostat.

### Electrochemical Measurements of GDE in Membrane Electrode Assembly (MEA) Cell

To prepare the cathode (1 cm²), the same GDE as in the flow cell was used to spray an overlayer of the Sustainion ionomer (Dioxide Materials) with a loading of 0.05 mg cm⁻² to improve contact with the solid electrolyte membrane. IrOₓ GDE (Dioxide Materials) and Sustainion membrane (Dioxide Materials) activated in 1 M CsOH were used as the anode (1 cm²) and membrane (˜4.5 cm²), respectively. A commercial MEA cell assembly (Fuel Cell Technologies) was used to compress the MEA at 30 N m. The MEA electrolyzer testing was performed at room temperature with 30 sccm CO₂ gas (99.999% Airgas) fed through a room temperature humidifier. The chronopotentiometry measurements were performed by holding the applied current for at least 6 minutes before stepping to the next current. Gas products from the MEA cell were quantified by injecting the outlet stream at the 5-minute mark of each applied current.

### Gas Supply and Detection

Carbon dioxide was provided to the electrochemical cell and its flow rate was controlled with a flow controller. The dry carbon dioxide stream could be supplied as dry gas. Effluent gas from the vapor-fed working electrode compartment was fed to a gas chromatograph (SRI Instruments), and two gas chromatograph injections were taken per electrode potential for product quantification to determine Faradaic efficiencies. After electrochemical measurements, the liquid electrolyte was collected and tested by 1H nuclear magnetic resonance spectroscopy (NMR; Varian Inova 600 MHz) to quantify selectivity towards liquid-phase products. To calculate faradaic efficiencies and current densities, measurements were taken 3 times to ensure repeatability for catalyst synthesis and CO₂ reduction testing of all tandem GDEs at each electrode potential.

### Calculation of Energy Efficiency

The energy efficiency (EE) was calculated using the following equation:

$$EE ( \% ) = {E}_{product}^{0} * {FE}_{product} / {E}_{cell}$$

where E⁰_{product} is the thermodynamic equilibrium potential of a product, FE_{product} is the faradaic efficiency of a product, and E_{cell} is the measured cell voltage between the cathode and the anode.

### Computational Details

Simulations of mass transfer are performed using STAR-CCM+ (Siemens). The simulation domain consists of a periodic sector of a cylinder of radius 400 nm and height 10 μm with NiNC and Cu₂O particles (100 and 30 nm radius, respectively) on the bottom. As described previously, the angle of the sector is varied to vary the Cu₂O:NiNC ratio. The concentrations of species i∈{CO, P} are governed by the steady diffusion equation

∇²Cᵢ=0.

On the NiNC particle surface, we have the following boundary conditions,

$$D ∇ {C}_{CO} \cdot n = J ,$$

$$∇ {C}_{P} \cdot n = 0 ,$$

where J is assumed to be 1×10⁻⁶ kmol m⁻² s⁻¹ and the diffusivities D of both CO and P are assumed to be both equal to 1×10⁻⁹ m² s⁻¹. However, it is important to note that the specific values chosen do not ultimately affect the dimensionless trends. On the Cu₂O particle surface, we have the following boundary conditions,

$${C}_{CO} = 0 ,$$

$$D ∇ {C}_{P} \cdot n = J + D ∇ {C}_{CO} \cdot n .$$

On the gas-liquid interface of the cylinder, the species are assumed to be perfectly adsorbing into the gas stream, i.e.,

Cᵢ=0.

On the periphery of the cylinder, no flux is assumed, i.e., ∇Cᵢ·n=0, and at the top of the cylinder, far away from the catalyst particles and gas liquid interface, there is assumed to be no species Cᵢ=0. Care is taken to select a simulation domain that is large enough—both in radius and in height—such that nearly all of the produced species leaves through the gas-liquid interface. The averaged dimensionless flux through the gas-liquid interface is calculated as

$$Flux = \frac{D}{JA} \int \frac{\partial {C}_{i}}{\partial y} dA ,$$

where A is the surface area of the gas-liquid interface.

### Physical Characterization

Catalyst GDEs were characterized ex situ by scanning electron microscopy (SEM; FEI Magellan 400 XHR, 5 kV), X-ray Photoelectron Spectroscopy (XPS; PHI Versaprobe 3 with Multipak data processing), and Grazing incidence (GI)-XRD diffraction (X'Pert Pro PANalytical Materials Research diffractometer). The SEM images and EDS results of the Cu₂O, Cu₂O/NiNC and NiNC gas diffusion electrodes were obtained using the EDAX/Ametek TEAM EDS system with an Octane Plus detector on a ThermoFisher Helios 6001 FIB/SEM operated at 15 KV. When taking SEM images, we used a 5 kV electron beam with 21 pA. The X-ray Photoelectron Spectroscopy (XPS) spectra were collected by a PHI Versaprobe 3 Scanning XPS Microscope with Multipak data processing. Grazing incidence (GI)-XRD (ω=1°) characterization of gas diffusion layer (GDL), Cu₂O (pre- and post-experimental) GDE, and Cu₂O/NiNC (pre- and post-experimental) GDE was performed using an X'Pert Pro PANalytical Materials Research diffractometer with a Cu Kα (λ=0.154 nm) x-ray source. All samples were fixed on a standard glass slide substrate holder for XRD measurements. Diffractograms were collected at a step size of 0.03° or 0.05° and a time per step of 1 s. The beam mask and divergence slit were varied to maximize the x-ray spot size while maintaining ω=1°.

FIG. 6 is a graph of XRD patterns of Cu and Cu/NiNC GDEs before and after electrochemical tests. FIG. 7 is a schematic illustration of a flow electrolyzer setup for vapor-fed CO₂ reduction

FIG. 8A, 8B, 8C are bar charts illustrating the distribution of gas phase products obtained with CuₓO gas diffusion electrodes with various catalyst loadings using 1 M KOH electrolyte for vapor-fed CO₂ reduction. (Yellow, purple, and orange bars indicate H₂, C₂H₄, and CO, respectively.)

FIG. 9 is a bar chart illustrating the potential dependent selectivity evaluation of CO₂ reduction of NiNC GDE in the vapor-fed CO₂ flow electrolyzer.

FIG. 10A, 10B are cross-section SEM images of Cu GDE and Cu/NiNC GDE, respectively, used for electrochemical testing.

FIG. 11 is a bar chart illustrating Faradaic efficiency and partial current density of C₂H₄ obtained with the Cu GDE at various potentials tested in 1M KOH electrolyte for CO reduction reaction.

FIG. 12A, 12B, 12C are bar charts showing product distributions obtained from Cu, Cu/NiNC-high, and Cu/NiNC-low, respectively, for electrocatalytic CO₂ reduction in 1 M KOH.

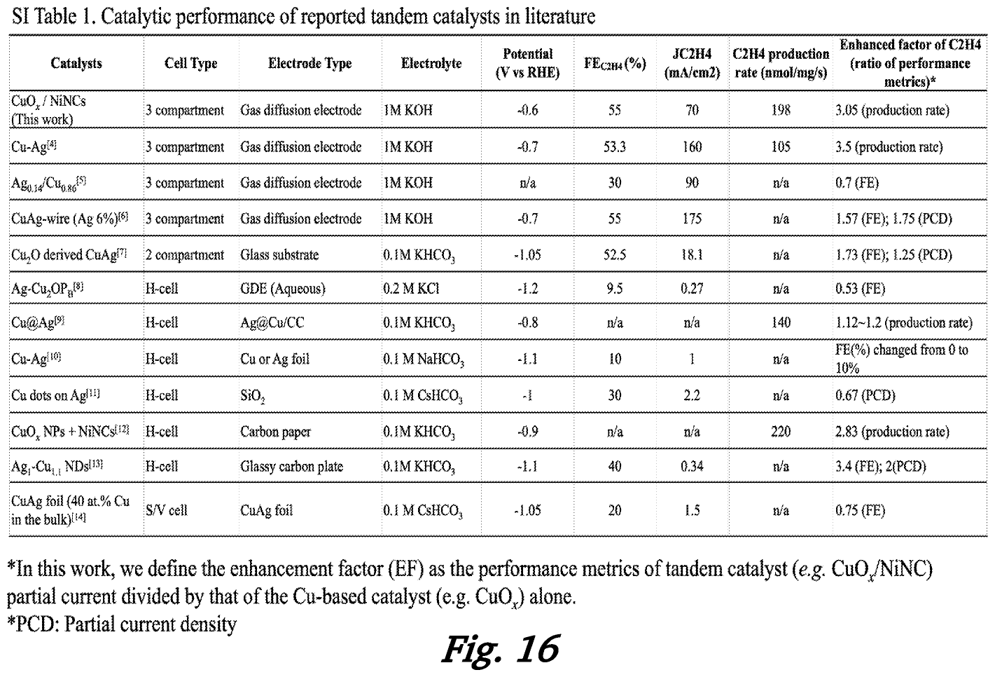

FIG. 16 is a table that shows catalytic performance of reported tandem catalysts in the literature.

FIG. 13A is a graph of Faradaic efficiency towards C₂H₄. FIG. 13B, 13C are graphs of partial current densities towards C₂H₄ and CO, respectively, obtained with different tandem GDEs at various potentials. FIG. 13D is a graph of C₂H₄/CO selectivity ratio obtained with different tandem GDEs at various potentials.

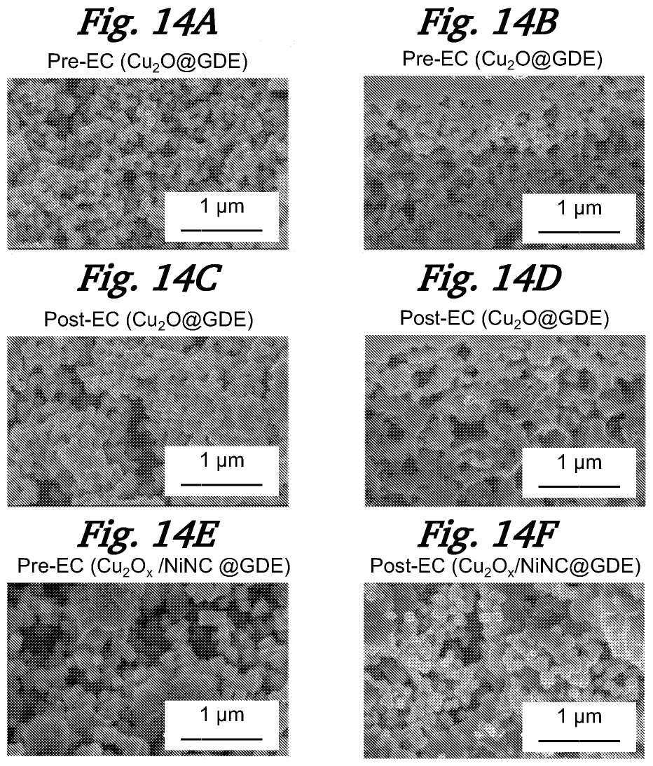

Top-view and cross-section SEM images are shown in FIGS. 9A-9F, where FIG. 14A, 14B show pre-experimental Cu GDE, where FIG. 14C, 14D show post-experimental Cu GDE, where FIG. 14E, 14F show pre- and post-experimental Cu/NiNC GDE under 1 M KOH electrolyte.

FIG. 15 is a plot showing cell voltage stability of the optimized Cu/NiNC performed in 1.0 M KHCO_{3(aq)} obtained at 100 and 150 mA cm⁻² current densities.

1. A process for converting carbon dioxide into a carbon-based molecule, the process comprising:
applying a working voltage to a tandem electrocatalyst integrated with a gas diffusion electrode;
providing a vapor-fed flow of the carbon dioxide to the tandem electrocatalyst integrated with the gas diffusion electrode;
catalyzing a direct-conversion reaction of the vapor-fed flow of the carbon dioxide to the carbon-based molecule using the tandem electrocatalyst integrated with the gas diffusion electrode.

2. The process of claim 1 wherein the tandem electrocatalyst consists of copper and nickel-coordinated nitrogen-doped carbon (NiNC), and wherein the carbon-based molecule is ethylene.

3. The process of claim 2 wherein the copper is in the form of nanoparticles, nanocubes, nanotubes, nanoflowers, nanorods, or nanoplates.

4. The process of claim 1 wherein the tandem electrocatalyst is a nanostructure composed of
1) a copper-based binary or ternary alloy, and
2) a metal center coordinated to a) nitrogen-doped carbon (NC) or b) a NC-containing macrocyclic organic compound.

5. The process of claim 4 wherein the copper-based binary or ternary alloy is in the form Cu—X-Y, where each of X, Y is a transition or post-transition metal.

6. The process of claim 5 wherein each of X, Y is selected from the group consisting of Ag, Zn, Al, and Sn.

7. The process of claim 4 wherein the copper-based binary or ternary alloy is in the form of nanoparticles, nanocubes, nanotubes, nanoflowers, nanorods, or nanoplates.

8. The process of claim 4 wherein the metal center is composed of a transition or post-transition metal.

9. The process of claim 8 wherein the metal center is Fe, Co, Ni, Ag, Zn, Al, or Sn.

10. The process of claim 4 wherein the macrocyclic organic compound is porphyrins or phthalocyanines with modified ligands.

11. The process of claim 4 wherein the metal center coordinated to nitrogen-doped carbon (NC) or to a NC-containing macrocyclic organic compound is in the form of nanoflowers, nanotubes, nanocages, mesopores, macropores, nanofibers, nanospheres, or other nanostructure.

12. The process of claim 1 wherein the carbon-based molecule is ethylene, ethanol, acetate, or a straight chain hydrocarbon with at least three carbon atoms.

13. The process of claim 1 implemented using a membrane electrode assembly electrolyzer.

14. The process of claim 1 implemented using a flow electrolyte electrolyzer.
